(19) United States
(12) Patent Application Publication
(10) Pub. No.: US 2017/0092072 A1
(43) Pub. Date: Mar. 30, 2017

(54) CLASS III GAME EMULATION

(71) Applicant: Casino Game Maker, Inc., Las Vegas, NV (US)

(72) Inventors: Andrzej Surmacz, Las Vegas, NV (US); Darin T. Gifford, Cedar City, UT (US); Cason J. Adams, Cedar City, UT (US); Brian R. Dalley, Cedar City, UT (US); Brooke Dunn, Henderson, NV (US)

(73) Assignee: Casino Game Maker, Inc., Las Vegas, NV (US)

(21) Appl. No.: 14/868,380

(22) Filed: Sep. 28, 2015

(51) Int. Cl. G07F 17/32

(52) U.S. Cl. CPC G07F 17/3267; G07F 17/3286; G07F 17/3244

(57) ABSTRACT

An apparatus is provided. The apparatus includes a processor that generates an electronic game card for a Class II game of chance and selects winning outcome indicia for the Class II game of chance. Further, the apparatus includes an emulation engine that generates an emulated Class III game based upon the winning outcome indicia for the Class II game of chance.

### BACKGROUND

1. Field

This disclosure generally relates to the field of gaming. More particularly, the disclosure relates to gaming devices utilized to operate games of chance.

2. General Background

Casinos typically include a variety of traditional and non-traditional card games, which are referred to as table games, in a human operated format. In other words, a human dealer typically operates a table game at a table in a casino on behalf of the casino.

Such human operated table games provide additional labor costs for the casinos. Such labor costs lead to casinos offering table games at higher limits and worse payout amounts. Further, casinos often have to implement strict security requirements to ensure that the human dealers are complying with casino rules. As a result, casinos are typically limited in the type of player experience that is provided to casino customers.

Further, casinos are typically required to provide a certain Return to Player (“RTP”) for a Class III game. The RTP is that amount provided to a player after a commission for the casino is deducted from a prize. For example, the RTP in Baccarat after a player places a wager on the Banker and a Banker win occurs is typically ninety eight and one half percent. In other words, the casino commission is only one and one half percent on a Banker win in a Baccarat game. Such limitations prevent casinos from providing higher prizes and better payouts than are typically provided to players.

### SUMMARY

In one aspect of the disclosure, an apparatus is provided. The apparatus includes a processor that generates an electronic game card for a Class II game of chance and selects winning outcome indicia for the Class II game of chance. Further, the apparatus includes an emulation engine that generates an emulated Class III game based upon the winning outcome indicia for the Class II game of chance.

In another aspect, a computer program product is also provided. The computer program product includes a computer readable program. The computer readable program when executed on a computer causes the computer to generate an electronic game card for a Class II game of chance. Further, the computer readable program when executed on the computer is caused to select winning outcome indicia for the Class II game of chance. In addition, the computer readable program when executed on the computer is caused to generate an emulated Class III game based upon the winning outcome indicia for the Class II game of chance.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates an electronic game emulation configuration.

FIG. 2 illustrates the internal components of the emulation engine illustrated in FIG. 1.

FIG. 3A illustrates an electronic bingo card that is displayed by the game data display 106.

FIG. 3B illustrates different possible lines as winning outcomes for the electronic bingo card illustrated in FIG. 3A.

FIG. 3C illustrates a line table that designates which line corresponds to which row.

FIG. 3D illustrates an example of Class II game data that is provided from the game server to the game terminal for display at the game data display.

FIG. 3E illustrates a display of the emulated game of Baccarat on the game data display.

FIG. 3F illustrates an example of Class II game data that is provided from the game server to the game terminal for display at the game data display for side wagers.

FIG. 4 illustrates an emulation selection configuration.

FIG. 5 illustrates a process that may be utilized to perform Class III game emulation.

### DETAILED DESCRIPTION

An electronic game emulation configuration provides the appearance of providing a first game of chance, but is operated according to a second game of chance that is a distinct type of game from the first game of chance. For example, a Class II gaming machine may provide the appearance of providing a Class III game, but determines an outcome according to a Class II format. An outcome for a Class II game is determined according to determining of a Bingo draw whereas an outcome for a Class III game is determined according to a random selection of indicia performed by a random number generator (“RNG”). A Class II game does not involve player skill, but the skill of the player may have effect on the outcome of a Class III game.

As an example, the electronic game emulation configuration may determine an outcome via a Class II game such as Bingo and emulate a Class III game such as Baccarat that is based upon the predetermined outcome of the Class II game. The electronic game emulation configuration improves the functioning of a computer by emulating a Class III game that is operated according to a Class II configuration so that a Class II game terminal can be played by a player in a format that appears to be a Class III game. The Class II game may or may not be limited to a finite quantity of bingo cards.

Although Baccarat is utilized as an example of a Class III game, a variety of Class III games may be utilized by the electronic game emulation configuration. For example, the Class III game may alternatively be Three Card Poker, Four Card Poker, Carribean Stud, Let It Ride, Ultimate Texas Hold 'Em, Casino War, etc. Further, a variety of other types of games may be utilized other than Bingo. For example, a lottery game may be utilized instead of Bingo. As an example of a Class III game other than Baccarat, five card poker may be utilized as the Class IIII game. Each card of poker would be emulated based on a distinct electronic bingo card.

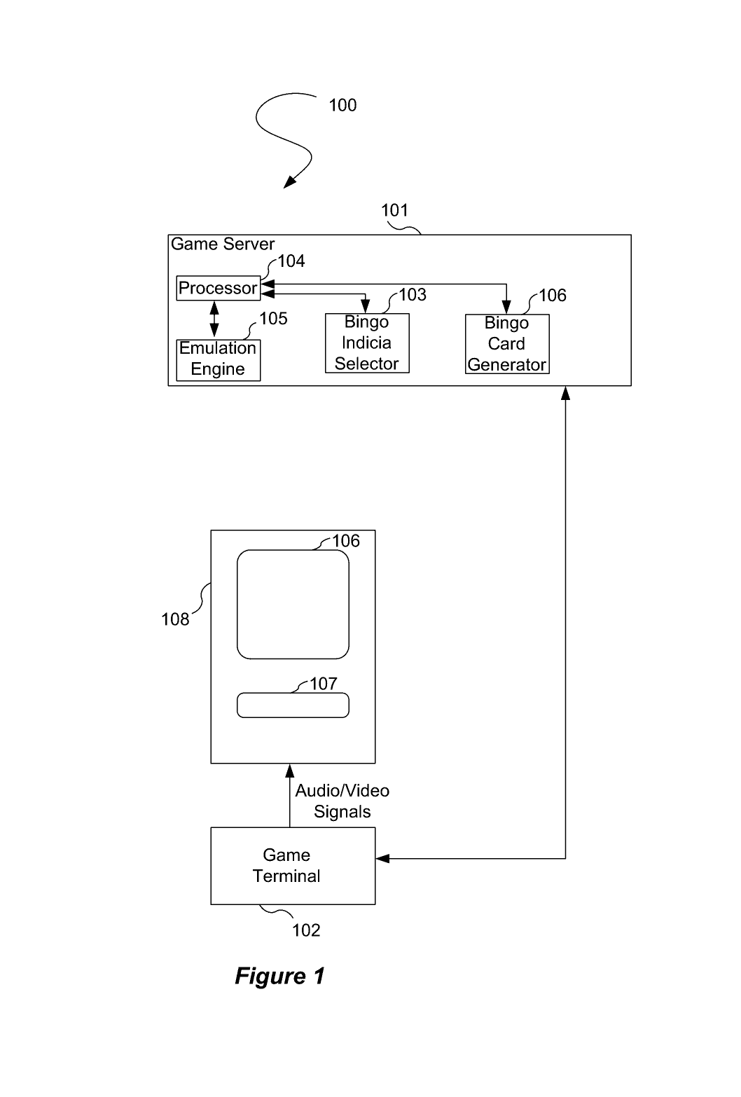

FIG. 1 illustrates an electronic game emulation configuration 100. The electronic game emulation configuration 100 has a game server 101 and a game terminal 102.

The game server 101 performs the game functionality to determine the outcome of a game. For example, the game server 101 may have a processor 104 that is in operable communication with a bingo indicia selector 103 that performs drawings for bingo indicia. The processor 104 may also be in operable communication with a bingo card generator 106 that generates a predetermined bingo card. For example, the bingo indicia selector 103 may be an electronic ball hopper that randomly selects a ball from a plurality of balls. The bingo card generator 106 may generate a bingo card with bingo indicia in a predetermined quantity of rows and columns. The processor 104 may then determine an outcome of a bingo game based on whether or not a bingo match occurs between the bingo card and the drawn bingo indicia. The bingo indicia may be numbers, characters, symbols, images, etc.

The processor 104 is also in operable communication with an emulation engine 105. Based on the outcome of the bingo game, the processor 104 requests the emulation engine 105 to emulate a Class III game, e.g., Baccarat, to provide the appearance that the Class III game was played. For example, the emulation engine 105 determines a Baccarat hand for the player that is similar to the bingo outcome.

The game server 101 then sends the Class II game data and the emulated Class III game data to a game terminal 102. The game terminal 102 sends audio/video signals to a game cabinet 108. The game cabinet 108 displays various game data, e.g., game graphics, game indicia selection, game score, etc. Such game data may be displayed on a game data display 106. Further, various input data, e.g., game wager, may be displayed via a game input display 107. For example, the game input display 107 may be a touch screen. The data displayed on the game input display 107 may alternatively be inputted via physical keyboard, keypad, cursor navigation device, menu navigation device, etc.

Further, various displays may be utilized as an alternative or in addition to the illustrated displays. For example, a single display may perform the functionality of the game data display 106 and the game input display 107. In addition, various displays such as topper screens, auxiliary screens, etc. may be utilized to display additional data, e.g., game graphics, player profile data, advertisements, etc.

The game terminal 102 may be a gaming device that is situated at a wagering event in a casino. Alternatively, the game terminal 102 may be a computing device that may or may not be situated at a wagering event in a casino. A computing device may be a personal computer (“PC”), laptop computer, tablet device, smartphone, etc.

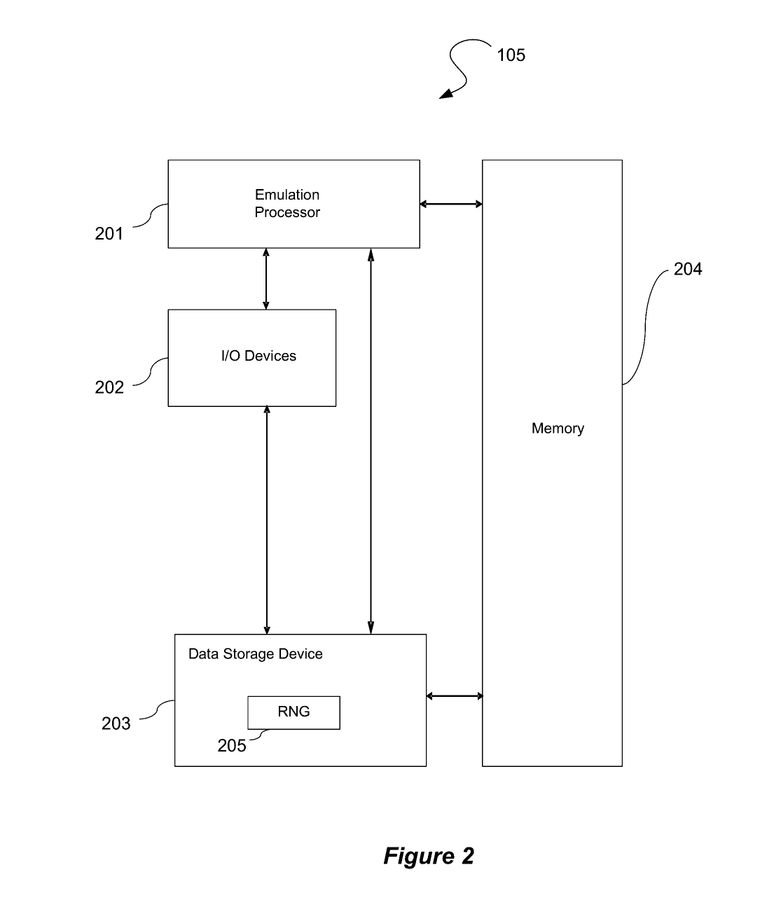

FIG. 2 illustrates the internal components of the emulation engine 105 illustrated in FIG. 1. The emulation engine 105 includes an emulation processor 201, input/output (“I/O”) devices 202, a data storage device 203, and a memory 204. The data storage device 203 may store code for an RNG 205 that the emulation processor 201 may utilize to emulate a Class III game.

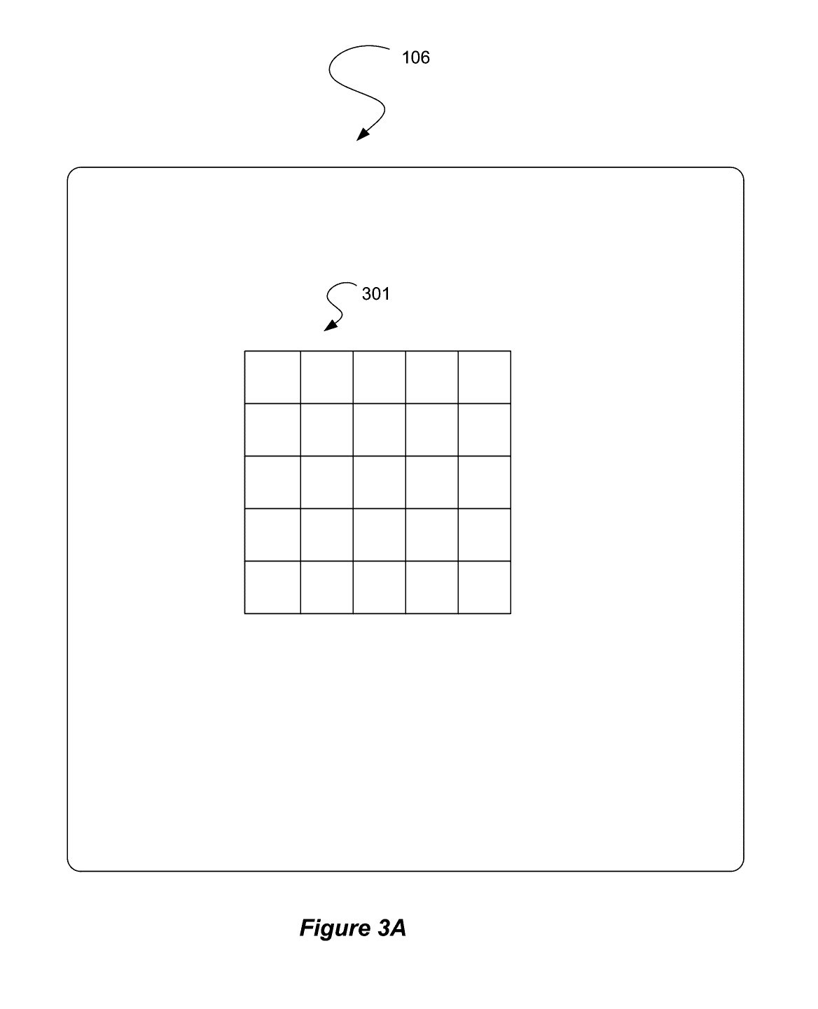

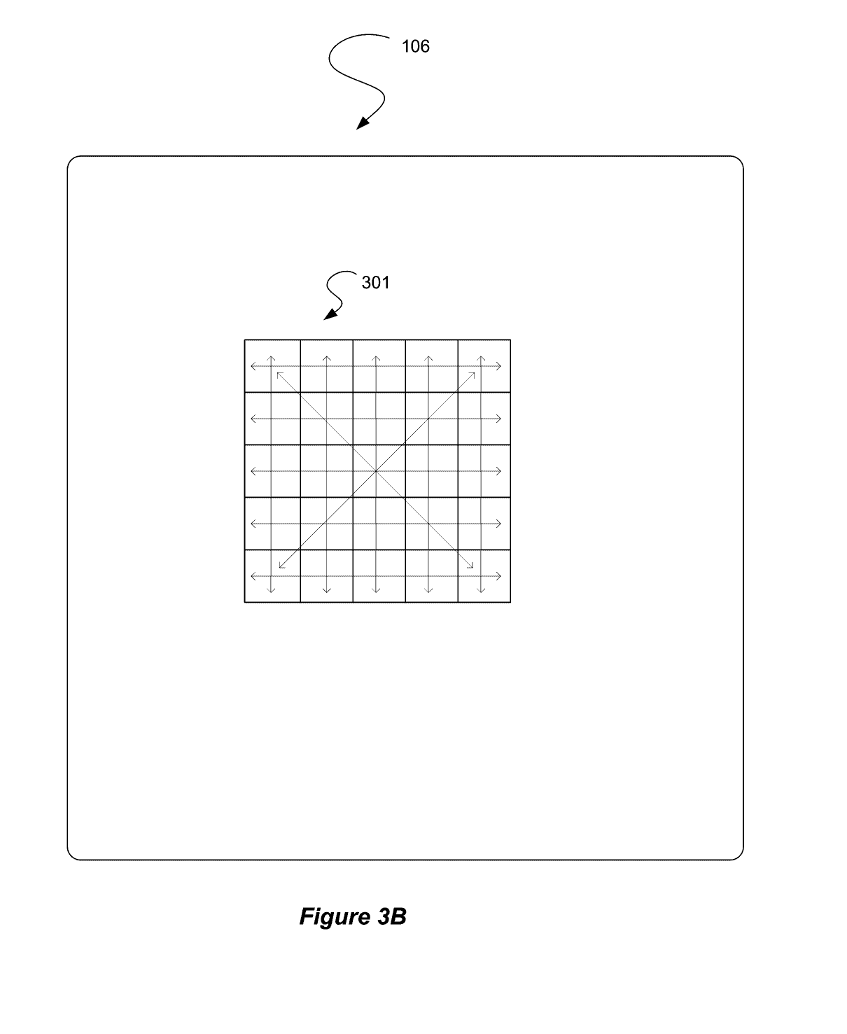

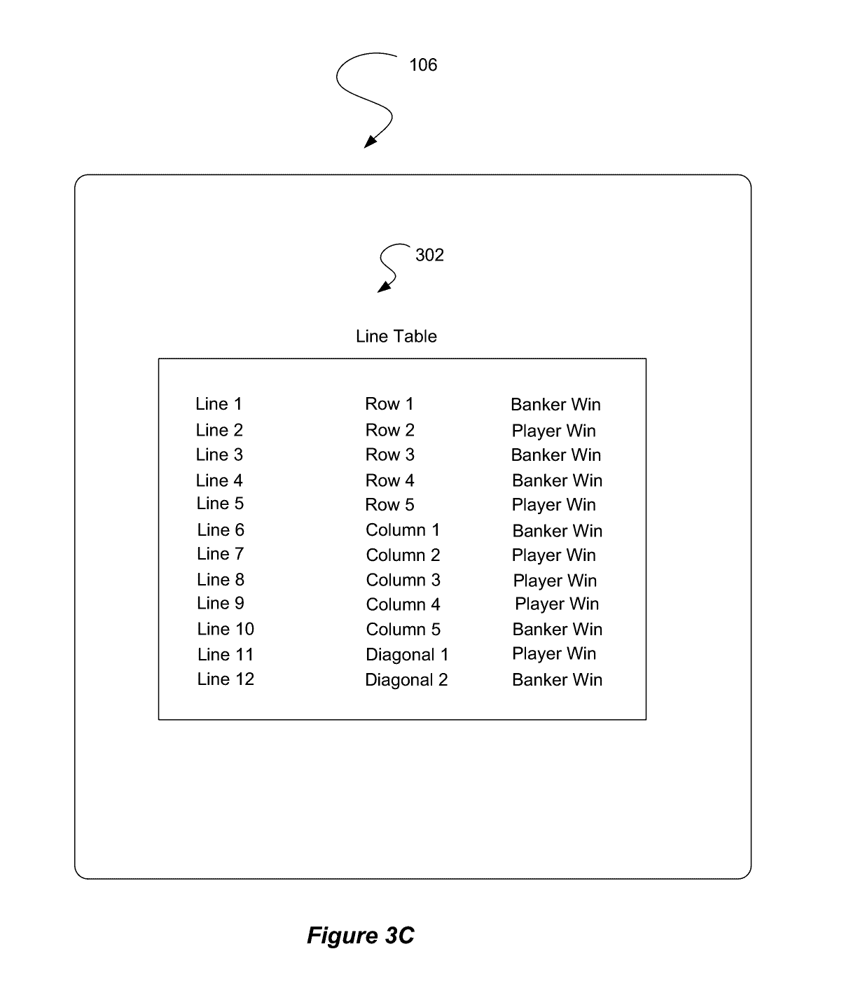

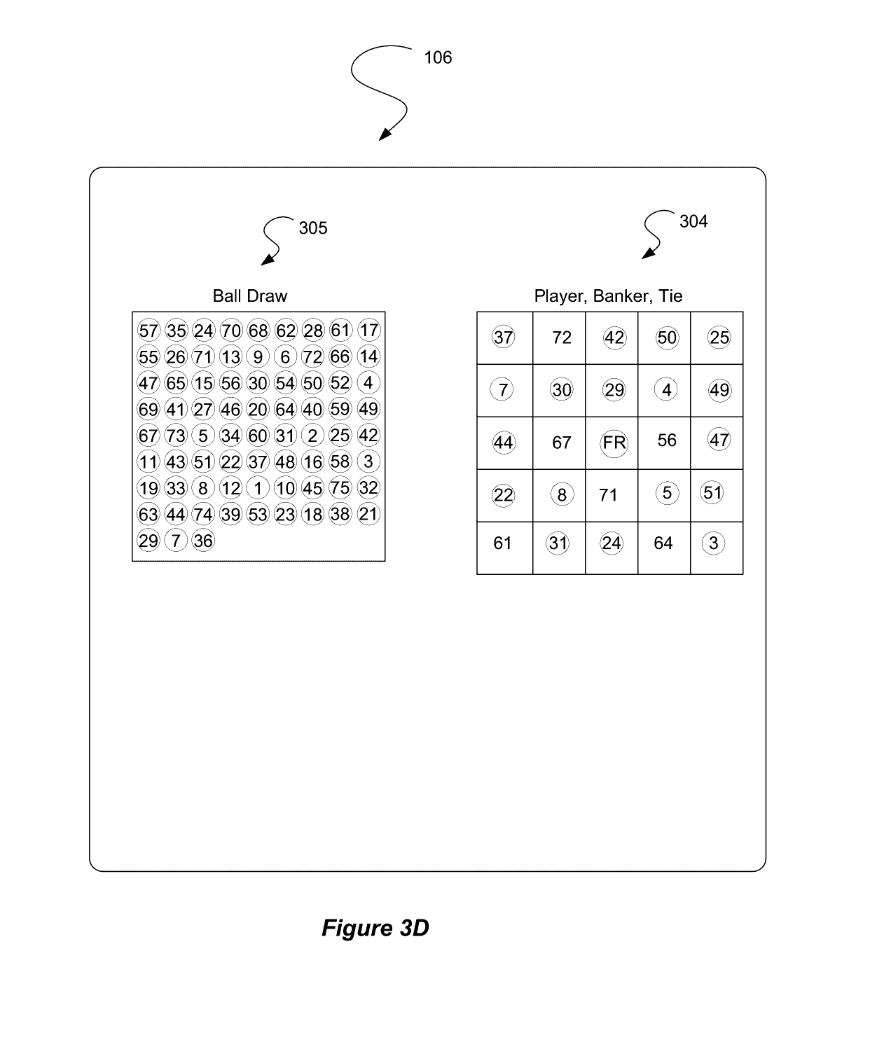

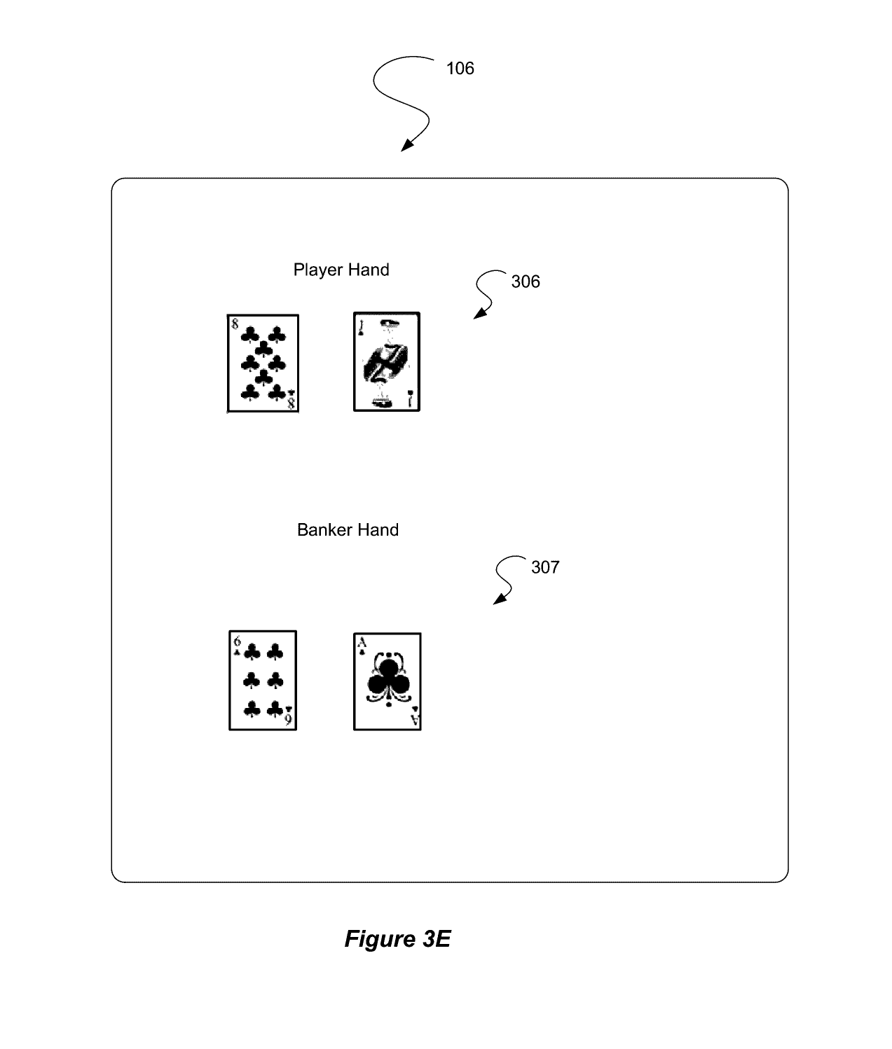

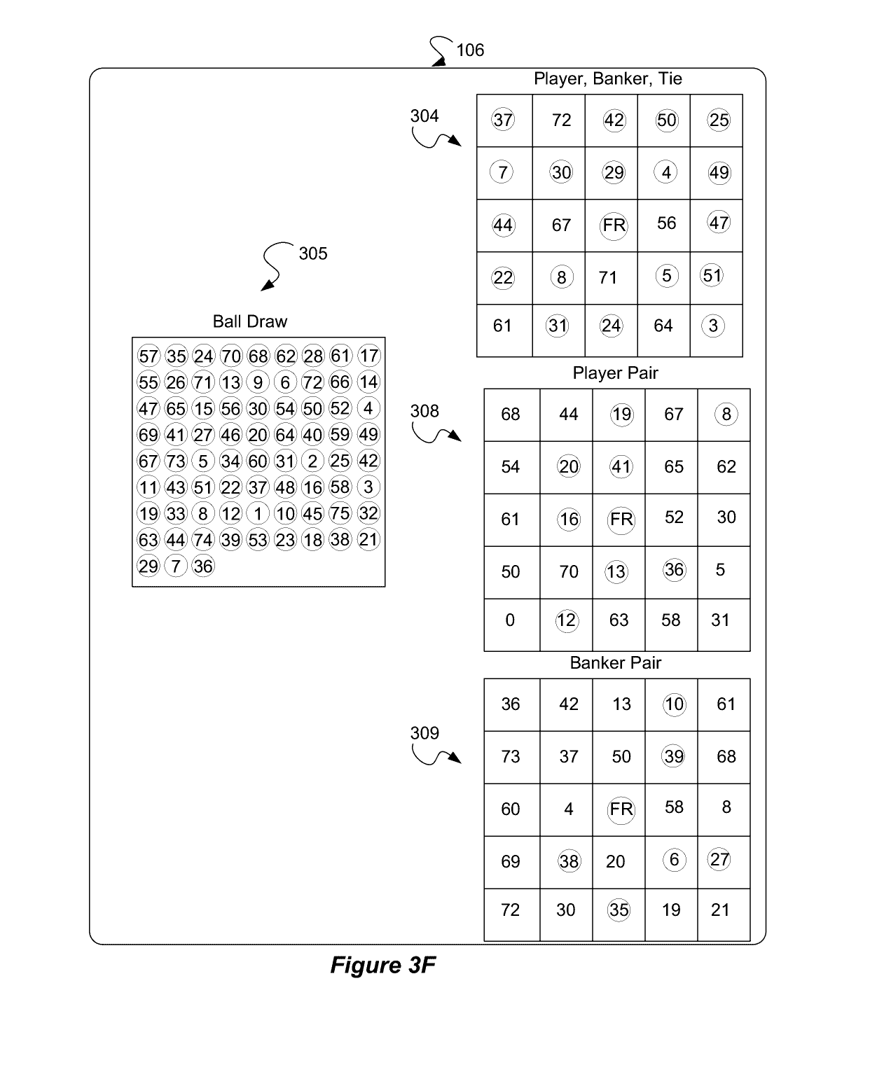

FIGS. 3A-3G illustrate examples of data that may be displayed by the game data display 106 illustrated in FIG. 1. FIG. 3A illustrates an electronic bingo card 301 that is displayed by the game data display 106. The electronic bingo card 301 is generated by the bingo card generator 106 illustrated in FIG. 1 and sent to the game terminal 102 by the game server 101.

The electronic bingo card 301 illustrated as having five rows and five columns to allow for the five letters of “BINGO” to appear as an outcome. Other quantities of rows and columns may alternatively be utilized for the electronic bingo card 301. For example, an electronic game card for a game that provides similar functionality to bingo may have a different name and a different quantity of letters than bingo.

FIG. 3B illustrates different possible lines as winning outcomes for the electronic bingo card 301 illustrated in FIG. 3A. For example, the letters of “BINGO” or an equivalent winning outcome, e.g., numbers designated by a pay table as a winning outcome, may appear in a row, column, or diagonal.

FIG. 3C illustrates a line table 302 that designates which line corresponds to which row. For example, lines 1-5 may designate rows 1-5 from top to bottom, lines 6-10 may designate columns 1-5 from left to right, line 11 may designate the diagonal with an upper right corner and a lower left corner, and line 12 may designate the diagonal with an upper left corner and a lower right corner. Other designations may be utilized for the lines for bingo outcomes. Further, other types of patterns, e.g., rectangle, triangle, particular squares, etc., may be utilized as an alternative or in addition to lines for determining winning bingo outcomes.

Further, an emulated game win is determined based upon the line at which the bingo winning outcome occurred. As an example of a Class III Baccarat game, a Banker win may be the outcome if a tie has not occurred and bingo is present at lines one, three, four, six, ten, and twelve. Further, a Player win may be the outcome if a tie has not occurred and bingo is present at lines two, five, seven, nine, and eleven. Other designations may be utilized for a corresponding winning outcome for a Player outcome or a Banker outcome.

FIG. 3D illustrates an example of Class II game data that is provided from the game server 101 to the game terminal 102 for display at the game data display 106. The Class II game data includes ball draw data 305 and a Player, Banker, Tie electronic bingo card 304. The ball draw data 305 includes the sequence of balls drawn by the game server 101. The bingo balls are drawn until the occurrence of the first bingo line winning outcome. The quantity of balls needed to get the line winning outcome occurrence determines if the Baccarat game outcome is a tie. The quantity of balls may be changed to allow for the RTP of the game to be modified to allow a casino to have a significantly less RTP than that of a typical Class III game such as Baccarat. The RTP may change while still paying the standard payout for each win type. The changes to the RTP may be performed via the outcome frequency.

If the outcome is not determined by to be a tie, the outcome is determined by associated different line wins to either the Player or Banker winning outcome. Depending on the quantity of lines associated with either the Player or Banker outcome, the probability of getting each outcome may be modified. Changing the probability and the pay table 303 illustrated in FIG. 3 will allow for the RTP of the game to be modified.

The balls that are drawn in the ball draw data 305 may be designated on the Player, Banker, Tie electronic bingo card 304 with an indicium, e.g., a circle, square, color, etc. Alternatively, the balls may not be designated to allow for a user to provide inputs to the game terminal 102 to select the designation that is verified by the game terminal 102. For instance, line two of the Player, Banker, Tie electronic bingo card 304 has a winning outcome for a Bingo game as the numbers seven, thirty, twenty nine, four, and forty nine appear in the ball draw data 305. As the bingo winning outcome occurs in line two of the electronic bingo card 304, the line table 302 provides that the emulated winning outcome is a Player win.

FIG. 3E illustrates a display of the emulated game of Baccarat on the game data display 106. As the emulated winning outcome from FIG. 3D is a Player win, the emulation engine 105 illustrated in FIG. 2 is utilized to randomly generate a player hand that is a winning outcome. For example, the emulation engine 105 illustrated in FIG. 1 may be utilized to select an emulated Baccarat hand for the Payer that is a winning Baccarat hand, e.g., a hand that totals eight or nine. Therefore, the emulated game of Baccarat displays a Player hand 306 of an eight of spades and a jack of spades, which total eight according the rules of Baccarat. Further, the emulated game of Baccarat displays a Banker hand 307 of a six of spades and an ace of spades, which total seven according to the rules of Baccarat.

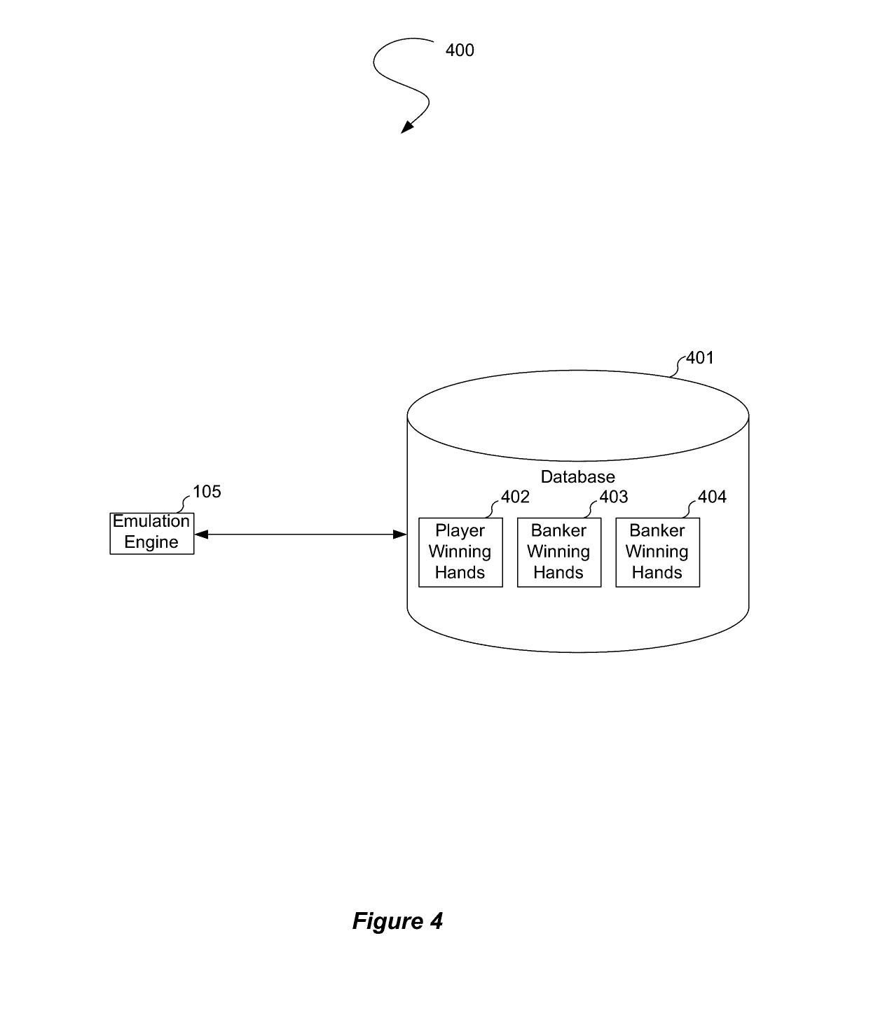

FIG. 4 illustrates an emulation selection configuration 400. In one embodiment, the emulation selection configuration 400 includes the emulation engine 105 illustrated in FIG. 1 and a database 401. For example, the emulation engine 105 may be in operable communication with the database 401 that stores predetermined winning Baccarat hands 402 for the Player, predetermined winning Baccarat hands 403 for the Banker, and predetermined hands 404 for the Player and the Banker that result in a tie. The emulation engine 105 may then randomly selects a winning hand from the set of hands corresponding to the line or other indicium that is utilized to determine a winning outcome or a tie based upon one or more electronic bingo cards 304 as illustrated in FIG. 3D.

Therefore, the user that places a wager on a Player or Banker is able to obtain the game play experience of Baccarat even though the game outcome is being determined according to the rules of Bingo. The user may or may not want to view the bingo game data illustrated in FIGS. 3C-3E. Therefore, the game terminal 102 provides the user with the ability to only view the display of the emulated Class III game or also view the Class II game data.

FIG. 3F illustrates an example of Class II game data that is provided from the game server 101 to the game terminal 102 for display at the game data display 106 for side wagers. For example, multiple electronic bingo cards may be played simultaneously, e.g., the electronic bingo card 304 for a Player, Banker, Tie, an electronic bingo card 308 for a Player Pair, and an electronic bingo card 309 for a Banker pair. The electronic bingo cards 304, 308, and 309 are all compared with the same ball draw data 305. Further, multiple RNGs may be utilized such that a distinct RNG is utilized for each of the electronic bingo cards 304, 308, and 309. Alternatively, the same RNG may be utilized for all of the electronic bingo cards 304, 308, and 309.

In another embodiment, the emulation selection configuration 400 may be performed without a database 401. For instance, the emulation engine 105 may dynamically select a winning Baccarat hand from a deck of cards. The deck of cards then has the remaining cards for subsequent Baccarat hands that are emulated. If the deck of cards does not have a winning Baccarat hand, a card shoe change may be displayed so that the emulation engine may utilize a new deck of cards. Further, the emulation engine 105 may select the winning Baccarat hand according to a variety of other configurations.

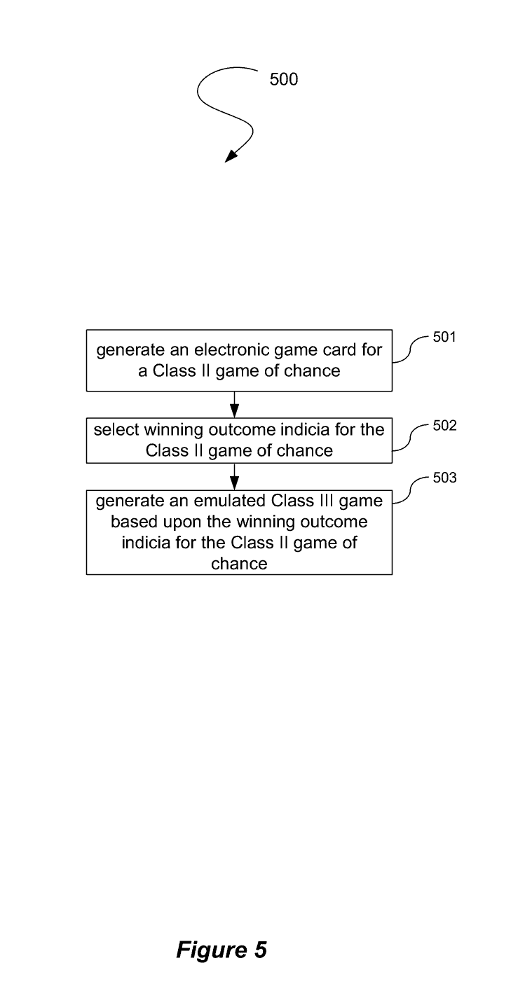

FIG. 5 illustrates a process 500 that may be utilized to perform Class III game emulation. At a process block 501, the process 500 generates an electronic game card for a Class II game of chance. Further, at a process block 502, the process 500 selects winning outcome indicia for the Class II game of chance. In addition, at a process block 503, the process 500 generates an emulated Class III game based upon the winning outcome indicia for the Class II game of chance.

In an alternative configuration, a Class III game may be emulated without utilizing a Class II game such as Bingo. For example, a table of randomly generated outcomes may be stored in a table instead of utilizing an electronic bingo card. For instance, the table may be randomly generated from “Player,” “Banker,” “Tie,” and “Banker and Player Pair.” As an example, the randomly generated table may be the following: “Banker,” “Banker,” “Banker,” “Player,” “Player,” “Tie,” “Banker and Player Pair,” “Banker and Banker Pair.” A randomly generated number of zero, one, or two would equate to a Banker win, a randomly generated number of three or four would equate to player win, a randomly generated number of five would equate to a tie, a randomly generated number of six would equate to a pair win for the Banker and the Player, and a randomly generated number of seven would equate to a pair win for the Banker and the Banker. A Class III game such as Baccarat may then be emulated by selecting Baccarat cards to emulate a win based upon the winner from the randomly generated table. Therefore, the Class III game may be emulated based upon other types of games other than Class II games. Further, the game that is emulated may or may not be a randomly generated game that is not considered a Class III game.

It is understood that the apparatuses, processes, and systems described herein may also be applied in other types of apparatuses, processes, and systems. Those skilled in the art will appreciate that the various adaptations and modifications of the embodiments of the apparatuses, processes, and systems described herein may be configured without departing from the scope and spirit of the present apparatuses, processes, and systems. Therefore, it is to be understood that, within the scope of the appended claims, the present apparatuses, processes, and systems may be practiced other than as specifically described herein.

We claim:

1. An apparatus comprising:
a processor that generates an electronic game card for a Class II game of chance and selects winning outcome indicia for the Class II game of chance; and
an emulation engine that generates an emulated Class III game based upon the winning outcome indicia for the Class II game of chance.

2. The apparatus of claim 1, wherein the processor sends the winning outcome indicia for the Class II game of chance to a game terminal.

3. The apparatus of claim 2, wherein the game terminal displays the winning outcome indicia for the Class II game of chance.

4. The apparatus of claim 1, wherein the processor sends data for the emulated Class III game data to a game terminal.

5. The apparatus of claim 4, wherein the game terminal displays the emulated game of chance.

6. The apparatus of claim 1, wherein the emulation engine selects an emulated outcome for the Class III game from a database of predetermined Class III winning outcomes.

7. The apparatus of claim 1, wherein a corresponding win of the emulated Class III game is determined based upon a line table.

8. The apparatus of claim 1, wherein the Class II game is bingo.

9. The apparatus of claim 1, wherein the Class III game is Baccarat.

10. The apparatus of claim 1, wherein the emulation engine further comprises a random number generator.

11. A computer program product comprising a computer readable storage device having a computer readable program, wherein the computer readable program when executed on a computer causes the computer to:
generate an electronic game card for a Class II game of chance;
select winning outcome indicia for the Class II game of chance; and
generate an emulated Class III game based upon the winning outcome indicia for the Class II game of chance.

12. The computer program product of claim 11, wherein the computer is further caused to send the winning outcome indicia for the Class II game of chance to a game terminal.

13. The computer program product of claim 11, wherein the computer is further caused to display the winning outcome indicia for the Class II game of chance.

14. The computer program product of claim 11, wherein the computer is further caused to send data for the emulated Class III game data to a game terminal display the winning outcome indicia for the Class II game of chance.

15. The computer program product of claim 11, wherein the computer is further caused to select an emulated outcome for the Class III game from a deck of cards such that the emulated outcome equates to a winning outcome for the Class II game of chance.

16. The computer program product of claim 11, wherein the computer is further caused to select an emulated outcome for the Class III game from a database of predetermined Class III winning outcomes.

17. The computer program product of claim 11, wherein a corresponding win of the emulated Class III game is determined based upon a line table.

18. The computer program product of claim 11, wherein the Class II game is bingo.

19. The computer program product of claim 11, wherein the Class III game is Baccarat.

20. The computer program product of claim 11, wherein the emulation engine further comprises a random number generator.
